(19) United States
(12) Patent Application Publication
(10) Pub. No.: US 2016/0132708 A1
(43) Pub. Date: May 12, 2016

(54) DISPLAYING METHOD AND DECODING METHOD FOR A DYNAMIC RECOGNIZABLE TWO-DIMENSIONAL CODE

(71) Applicant: Kuei-Sheng TSOU, Hsinchu (TW)

(72) Inventor: Kuei-Sheng TSOU, Hsinchu (TW)

(21) Appl. No.: 14/929,906

(22) Filed: Nov. 2, 2015

Related U.S. Application Data
(63) Continuation-in-part of application No. 14/534,831, filed on Nov. 6, 2014.

(51) Int. Cl. G06K 7/14; G06K 19/06

(52) U.S. Cl. CPC G06K 7/1417; G06K 19/06037; G06K 19/06103

(57) ABSTRACT

A displaying method for a dynamic recognizable two-dimensional code is disclosed, including: providing at least a two-dimensional code; providing at least a recognizable image; and sequentially displaying the at least a two-dimensional code and the at least a recognizable image on a display unit of an electronic device according to a displaying pattern, which defining a displaying sequence of displayed images with associated displaying duration and time interval to the next in the sequence, defined as the time lapse between a displayed image ending and a next displayed image appearing. A decoding method for a dynamic recognizable two-dimensional code is further disclosed. The present invention can display various types of the dynamic recognizable two-dimensional code by setting a two-dimensional code, a recognizable image, and a displaying pattern aiming to improve users' convenience and facilitate further interaction between electronic devices.

### CROSS-REFERENCE TO RELATED APPLICATION

This application is a continuation-in-part of U.S. patent application Ser. No. 14/534,831, filed on Nov. 6, 2014, which is incorporated herewith by reference.

### TECHNICAL FIELD

The technical field generally relates to a displaying method and a decoding method for a dynamic recognizable two-dimensional (2D) code; and in particular, relates to displaying method and a decoding method for a dynamic recognizable two-dimensional code that is used for interaction between electronic devices.

### BACKGROUND

Two-dimensional (2D) codes are widely used in the current market. Some of the common 2D-code includes Code 49, Code 16K, PDF417, SuperCode, Dot Code A, USS Code One, MaxiCode, Data Matrix, Aztec Code, QR Code and the like.

The Quick Response Code (QR-code) is one of matrix barcodes which was originally designed for industrial applications, but has gained popularity in consumer market.

With the advancement of technology and application, additional features are continuously added to the QR-code; one of the common added features is the recognizability to human eyes, which also leads to the creation of customized style. For example, when selecting a QR-code for the user, a recognizable QR-code is developed to include a static image that is recognizable to human eye, to enhance convenience to users. However, the basic function of the QR-code in commercial and advertising application remains the same. That is, a capturing device captures a QR-code; and after decoding the captured QR-code, the capturing device displays the data represented by the QR-code, transmits and receives data, or links to a specific website.

### SUMMARY

In view of the drawbacks of the prior art, one of the objectives of the present invention is to provide a displaying method for a dynamic recognizable two-dimensional code and a decoding method for a dynamic recognizable two-dimensional code.

An exemplary embodiment describes a displaying method for a dynamic recognizable two-dimensional code of the present invention, applicable to an electronic device with a display unit, includes the following steps of: providing at least a two-dimensional code, wherein the two-dimensional code is an image encoded according to a two-dimensional code format; providing at least a recognizable image, wherein the recognizable image is recognizable by human eyes; and sequentially displaying the at least a two-dimensional code and the at least a recognizable image on the display unit of the electronic device according to a displaying pattern, wherein the displaying pattern defines a displaying sequence of displayed images, a displaying duration of each of the displayed images, and a time interval to a displayed image next in the sequence, defined as the time lapse between a displayed image ending and a next displayed image appearing; and wherein each of the displayed images being one of the at least a two-dimensional code or the at least a recognizable image.

According to a preferred embodiment, the recognizable image is an image that is recognizable by human eyes, but not be recognized by a two-dimensional code decoder in accordance with the two-dimensional code formats, a blank image, a transparent page or any combination of the above.

According to a preferred embodiment, the displaying duration of each of the displayed images is not all the same, and the time interval to a displayed image next in the sequence is not all zero.

According to a preferred embodiment, the displaying duration of each of the displayed images is the same, and the time interval to a displayed image next in the sequence is zero.

According to a preferred embodiment, the display unit is a touch screen, when touching the recognizable two-dimensional code displayed on the touch screen, the touching is detected by an application program stored in a storing unit of the electronic device, and triggers a subsequent operation defined by the application program.

Another exemplary embodiment describes a decoding method for a dynamic recognizable two-dimensional code of the present invention, applicable to a first electronic device having a display unit and a second electronic device having a camera unit, includes the following steps of: providing at least a two-dimensional code, wherein the two-dimensional code is an image encoded according to a two-dimensional code format; providing at least a recognizable image, wherein the recognizable image is recognizable by human eyes; sequentially displaying the at least a two-dimensional code and the at least a recognizable image on the display unit of the first electronic device according to a displaying pattern, wherein the displaying pattern defines a displaying sequence of displayed images, a displaying duration of each of the displayed images, and a time interval to a displayed image next in the sequence, defined as the time lapse between a displayed image ending and a next displayed image appearing; and wherein each of the displayed images being one of the at least a two-dimensional code or the at least a recognizable image; using the camera unit of the second electronic device to capture the dynamic recognizable two-dimensional code displayed on the display unit of the first electronic device; performing decoding on the dynamic recognizable two-dimensional code, and to determine the at least a two-dimensional code and the at least a recognizable image, and the displaying pattern; defining the determined two-dimensional codes as a first state, defining the recognizable images as a second state, and defining the first state and the second state to be opposite to each other; computing to obtain a verification code based on the determined displaying pattern, and the states of the recognizable images and the two-dimensional codes, the sequence of the displayed images; and determining whether a subsequent operation is performed based on the computed verification code.

According to a preferred embodiment, the recognizable image is an image that is recognizable by human eyes, but not be recognized by a two-dimensional code decoder in accordance with the two-dimensional code formats, a blank image, a transparent page or any combination of the above.

According to a preferred embodiment, the displaying duration of each of the displayed images is not all the same, and the time interval to a displayed image next in the sequence is not all zero.

According to a preferred embodiment, the displaying duration of each of the displayed images is the same, and the time interval to a displayed image next in the sequence is zero.

According to a preferred embodiment, the subsequent operation includes interaction between the first electronic device and the second electronic device.

According to a preferred embodiment, the subsequent operation includes decoding and using the data encoded in the two-dimensional codes of the dynamic recognizable two-dimensional code.

The displaying method and the decoding method for a dynamic recognizable two-dimensional code of the present invention can display various types of the dynamic recognizable two-dimensional code by setting a displaying pattern. Together with decoding of the dynamic recognizable two-dimensional code, the present invention improves users' convenience and facilitates various interactions between electronic devices.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 is a flow chart showing the displaying method of the dynamic recognizable two-dimensional (2D) code in accordance with a preferred embodiment of the present invention.

FIG. 2 is a schematic diagram that is consistent with the preferred embodiment of FIG. 1, and shows a 2D code and a recognizable image of the dynamic recognizable 2D code.

FIG. 3 is a schematic diagram that is consistent with the preferred embodiment of FIG. 1, and shows a displaying sequence of the dynamic recognizable 2D code.

FIG. 4 is a flow chart showing the decoding method of the dynamic recognizable 2D code in accordance with a preferred embodiment of the present invention.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It should be noted that the structures, proportions, sizes and the like of the drawings of the current specification are only for depicting the disclosures of the present invention, to enable easy reading and understanding by persons skilled in the art, and these are not meant to be conditions that limit the present invention. As such, the drawings are not technologically meaningful. Any modifications of the structure, proportion relationships or any adjustments of the sizes should fall within the scope that is covered by the technical content of the present invention, without affecting the effects produced by the present invention and without affecting the goals of the present invention.

In the following preferred embodiments, the QR code is used as an example of the two-dimensional (2D) code, in order to describe the structure and use of the present invention. However, it should be noted that, the technical features of the present invention is also suitable for other types of 2D codes.

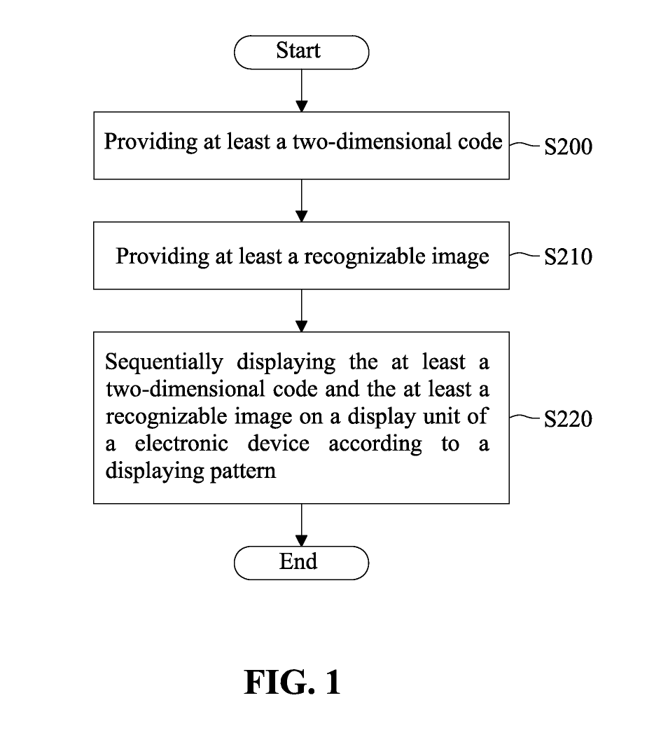

FIG. 1 is a flow chart showing the displaying method of the dynamic recognizable 2D code in accordance with a preferred embodiment of the present invention. As shown in FIG. 1, the displaying method for the dynamic recognizable 2D code includes the following steps:

Step S200: at least a 2D code is provided; whereby the 2D code is an image representing data and encoded in accordance with a 2D code format.

Step S210: at least a recognizable image is provided, whereby the recognizable image is an image that is recognizable by human eyes.

Step 220: the at least a 2D code and the at least a recognizable image are sequentially displayed on a display unit of an electronic device, in accordance with a displaying pattern. The displaying pattern includes defining a sequence of displayed images, the displaying duration of each of the displayed images, as well as the time interval to a displayed image next in the sequence, defined as the time lapse between a displayed image ending and a next displayed image appearing. Each of the displayed images being one of the at least a 2D code or the at least a recognizable image.

It should be noted that the sequence of the displayed images, the displaying duration of each of the displayed images and time intervals to the next displayed image may be changed to meet requirements of different applications. The display unit of the electronic device may display the various dynamic recognizable 2D codes.

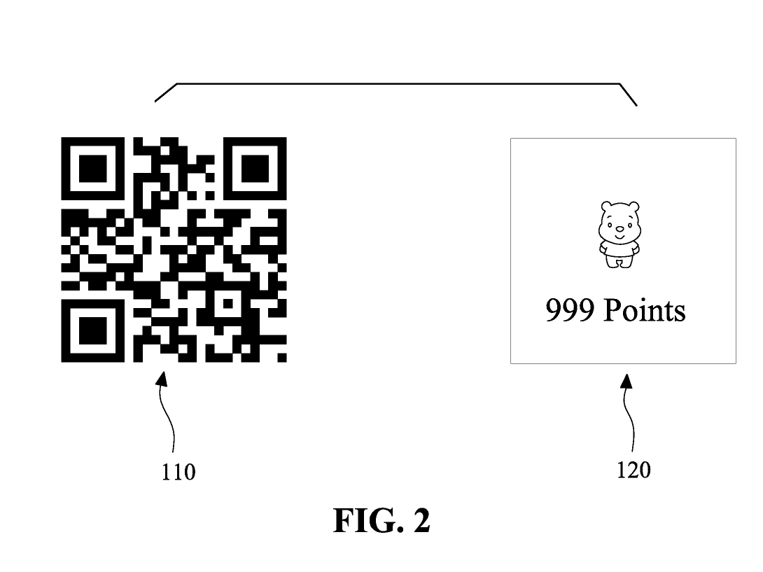

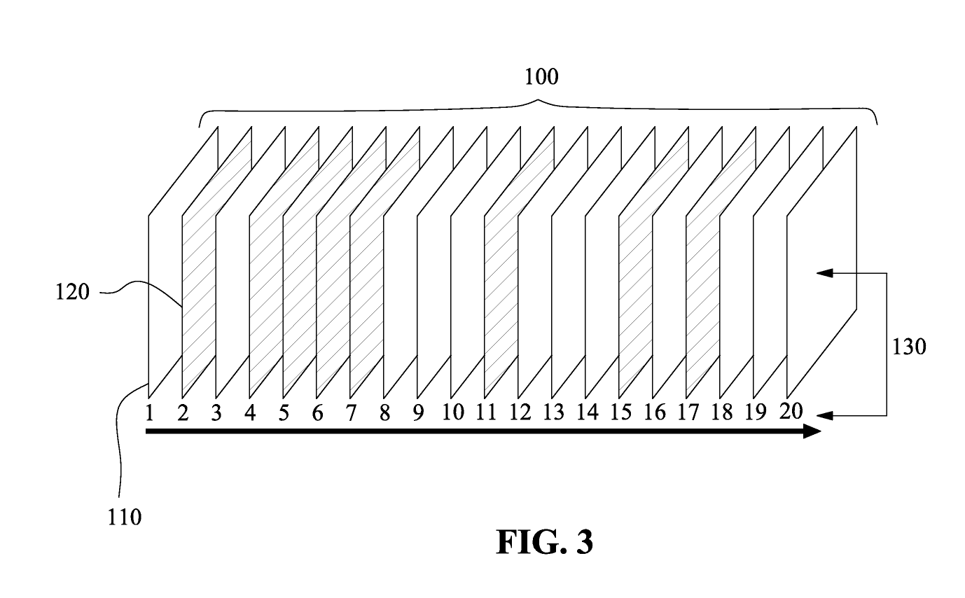

FIG. 2 is a schematic diagram that is consistent with the preferred embodiment of FIG. 1, and shows a 2D code and a recognizable image of a dynamic recognizable 2D code. FIG. 3 is a schematic diagram consistent with the preferred embodiment of FIG. 1, and shows a displaying sequence of a dynamic recognizable 2D code. As shown in FIG. 2 and FIG. 3, a dynamic recognizable 2D code 100 for interaction between electronic devices, applicable to a first electronic device able to display the dynamic recognizable 2D code 100 and a second electronic device able to capture with a camera unit the dynamic recognizable 2D code 100 displayed on the display unit of the first electronic device. The dynamic recognizable 2D code 100 includes at least a 2D code 110, at least a recognizable image 120, and a displaying pattern 130 having a display period T. The 2D code 110 is formed by converting a plurality of data into an image encoded in accordance with the 2D code format. The recognizable image 120 is an image that is recognizable by human eyes, and is an image that cannot be recognized by a 2D code decoder in accordance with 2D code formats. The displaying pattern 130 defines a sequence of displayed images, wherein each of the displayed images being one of the at least a 2D code or the at least a recognizable image. Each of the displayed images in the sequence is associated with a displaying duration (the length of the displaying of the displayed image) and a time interval to a displayed image next in the sequence, defined as the time lapse between a displayed image ending and a next displayed image appearing. Also, the dynamic recognizable 2D code 100 may be displayed cyclically. In a preferred embodiment of the present invention shown in FIG. 3, the displaying pattern 130 includes a sequence of twelve 2D codes 110 and eight recognizable images 120, with each being set with a one-twentieth of the duration of the display period T for displaying duration, and time interval being set as zero (i.e., the next image is displayed immediately following the previous image). It should be noted that the displaying duration and the time interval associated with each displayed image are not shown in FIG. 3.

However, it should be noted that the exemplary embodiment is only illustrative, instead of restrictive. A different displaying pattern can be defined based on application requirements. As aforementioned, the sequence of the displayed images, the displaying duration and time intervals to the next displayed image may all be changed to meet requirements of different applications. Moreover, the display unit of an electronic device may display the various dynamic recognizable 2D codes.

When a user touches the recognizable image 120 of the dynamic recognizable 2D code 100 displayed on a touch screen of an electronic device, the touching by the user is detected by an application program of the electronic device. Therefore, a user is touching the dynamic recognizable 2D code 100 and detected by the application program may trigger one or more subsequent operations defined by the application program.

Moreover, the 2D code 110 is an image recognizable by a 2D code decoder in accordance with 2D code formats. The 2D code 110 may be a conventional 2D code, a 2D code partially overlapped by an image recognizable to the human eyes and the like.

Moreover, the recognizable image 120 is defined as an image that is recognizable by human eyes, but cannot be recognized by a 2D code decoder based on 2D code formats, such as, a picture or drawing of dolls, trees, flowers and grass, numerical signs, company trademarks, photos, a blank page or a transparent page, and the like.

Moreover, it should be noted that the displaying duration of each of the displayed images may or may not be the same, and the time interval to a displayed image next in the sequence may or may not be zero. A zero time interval to a displayed image next in the sequence means that the next displayed image appears immediately after the previous displayed image ends.

In addition, it should also be noted that in the displaying pattern 130, each of the 2D-code 110 and the recognizable image 120 may be different.

The plurality of data encoded in accordance with a 2D code format may vary depending on the application and the interaction between the electronic devices. In an embodiment, for example, the data may include at least a device data to identify the first displaying electronic device, an information exchange protocol to indicate the interaction between two electronic devices conducted through the dynamic recognizable 2D-code 100, and a validation key for pairing and matching between two electronic devices conducting the interaction.

Specifically, the dynamic recognizable 2D code 100 of the present invention can be displayed on a display unit of an electronic device. A sequence of 2D codes 110 and recognizable images 120, that is, displayed images, are displayed following a displaying pattern 130 on a display unit of an electronic device, wherein the displaying pattern 130 defines a displaying sequence of displayed images, with each displayed images in the sequence associated with a displaying duration and time interval to the next in the sequence. Also, the dynamic recognizable 2D code 100 may be displayed cyclically.

In actual application, the dynamic recognizable 2D code 100 may be appeared in any of the following forms at least:

Similar to static 2D codes: in this form, each displayed images are associated with a short displaying duration and a zero-length time interval. As such, the human eyes are unable to detect the dynamic recognizable 2D code 100 is formed by a sequence of displayed images which displaying time are all short and fast, wherein all the 2D codes 110 are the same, and the recognizable image 120 is either a blank image or a transparent page.

Dynamic flashing 2D code: two variations are included in this form. The first involves the recognizable images 120 and the same 2D codes 110, within the recognizable image 120 can overlap the 2D code 110. In the second variation, the displaying time associated with the displayed images is set longer, wherein the recognizable image 120 includes at least a blank image or a transparent page. As the blank or transparent page associated with a longer displaying duration is displayed, the dynamic recognizable 2D code 100 creates a flashing effect to the human eyes.

2D code with motion image: in this form, the 2D codes 110 of the dynamic recognizable 2D code 100 may be the same or different, and the recognizable images 120 must include a plurality of recognizable images constituting a motion picture. When the sequence of displayed images is displayed quickly, a dynamic effect of motion picture is created for the human eyes through the continuity of the recognizable images.

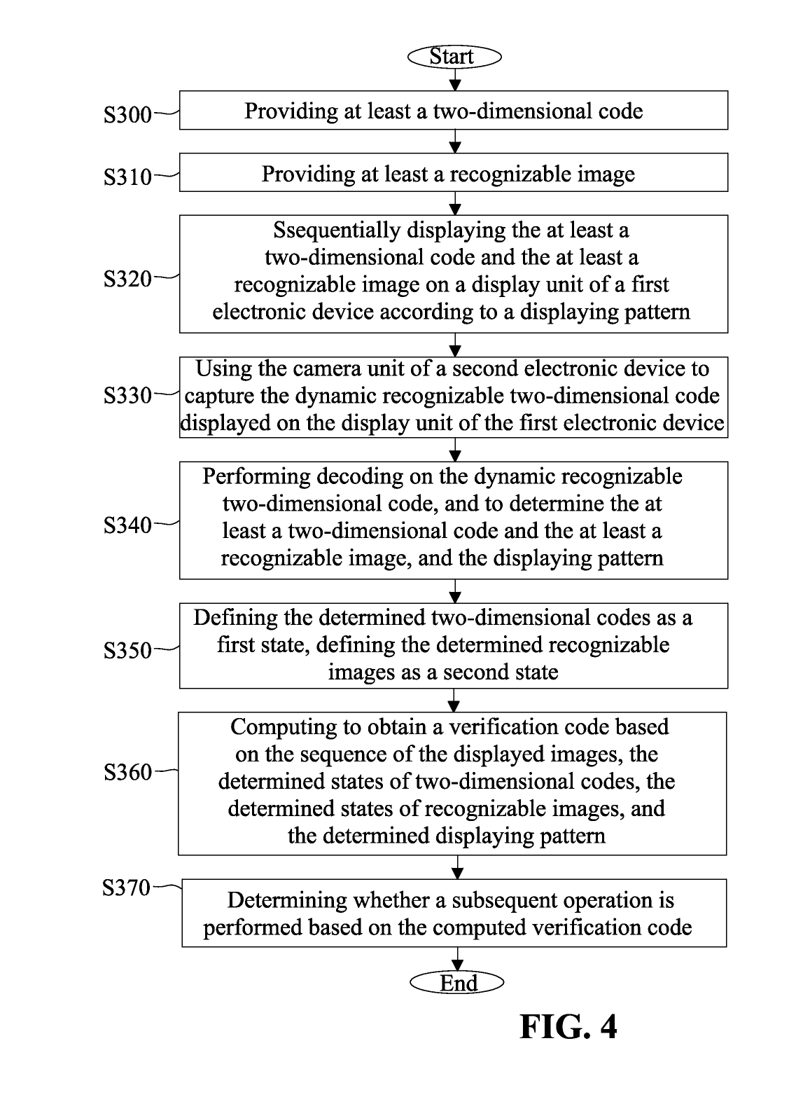

FIG. 4 is a flow chart showing the decoding method of the dynamic recognizable 2D code in accordance with a preferred embodiment of the present invention. As shown in FIG. 4, the decoding method of the dynamic recognizable 2D code of the present invention includes the following steps:

Step S300: at least a 2D code is provided; whereby the 2D code is an image representing data and encoded in accordance with a 2D code format.

Step S310: at least a recognizable image is provided, whereby the recognizable image is an image that may be recognizable by human eyes.

Step 320: the at least a 2D code 110 and the at least a recognizable image 120 are sequentially displayed on a display unit of a first electronic device, in accordance with a displaying pattern 130. The displaying pattern includes defining a sequence of displayed images, the displaying duration of each of the displayed images, as well as the time interval to a displayed image next in the sequence, defined as the time lapse between a displayed image ending and a next displayed image appearing. Each of the displayed images being one of the at least a 2D code 110 or the at least a recognizable image 120.

Step S330: capturing the dynamic recognizable 2D code 100 displayed on the display unit. For example, a camera unit of a second electronic device is used to capture the dynamic recognizable 2D code 100 displayed on the display unit of the first electronic device. However, the exemplar is only illustrative, instead of restrictive.

Step S340: performing decoding on the dynamic recognizable 2D code 100, and to determine the 2D codes and the recognizable images, and the displaying pattern.

Step S350: defining the determined 2D codes as a first state, defining the determined recognizable images as a second state, and defining the first state and the second state to be opposite to each other.

Step S360: computing to obtain a verification code based on the sequence of the displayed images, the determined states of 2D codes, the determined states of recognizable images, and the determined displaying pattern.

Step S370: determining whether a subsequent operation is performed based on the computed verification code.

As shown in FIG. 1 and FIG. 4, the above-mentioned steps S300-S320 are the same as the steps S200-S220 of FIG. 1. Since steps S200-S220 have been described in detail above, therefore steps S300-S320 will not be described here. The steps of S330-S370 are explained as follows:

The dynamic recognizable 2D code 100 may be used to generate a verification code, used between two electronic devices for verification purpose. For example, when a dynamic recognizable 2D code 100 is captured by the camera unit of the second electronic device, the 2D code 110 and the recognizable image 120 of the dynamic recognizable 2D code 100 are determined by a 2D code decoder, according to the 2D code formats. The 2D code 110 and the recognizable image 120 are then presented in two opposite states, respectively. For example, the two opposite states are “1” and “0” or “high” and “low,” respectively. After the computation is performed, a “verification code” formed by a sequence of “1” and “0” may well be obtained; and the determination of the “verification code” may decide whether any subsequent operation is triggered depending on an application program. The subsequent operation may further include performing interactive operations between two electronic devices, or may further include deciding whether or not to perform the decoding (of) and using the data encoded in the 2D codes 110 of the dynamic recognizable 2D code 100 captured by the second electronic device.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A displaying method for a dynamic recognizable two-dimensional code, applicable to an electronic device with a display unit, comprising the following steps of:
providing at least a two-dimensional code, wherein the two-dimensional code is an image encoded according to a two-dimensional code format;
providing at least a recognizable image, wherein the recognizable image is recognizable by human eyes; and
sequentially displaying the at least a two-dimensional code and the at least a recognizable image on the display unit of the electronic device according to a displaying pattern, wherein the displaying pattern defines a displaying sequence of displayed images, a displaying duration of each of the displayed images, and a time interval to a displayed image next in the sequence, defined as the time lapse between a displayed image ending and a next displayed image appearing; and wherein each of the displayed images being one of the at least a two-dimensional code or the at least a recognizable image.

2. The displaying method for a dynamic recognizable two-dimensional code as claimed in claim 1, wherein the recognizable image is an image that is recognizable by human eyes, but not be recognized by a two-dimensional code decoder in accordance with the two-dimensional code formats, a blank image, a transparent page or any combination of the above.

3. The displaying method for a dynamic recognizable two-dimensional code as claimed in claim 1, wherein the displaying duration of each of the displayed images is not all the same, and the time interval to a displayed image next in the sequence is not all zero.

4. The displaying method for a dynamic recognizable two-dimensional code as claimed in claim 3, wherein the displaying duration of each of the displayed images is the same, and the time interval to a displayed image next in the sequence is zero.

5. The displaying method for a dynamic recognizable two-dimensional code as claimed in claim 1, wherein the display unit is a touch screen, when touching the dynamic recognizable two-dimensional code displayed on the touch screen, the touching is detected by an application program stored in a storing unit of the electronic device, and triggers a subsequent operation defined by the application program.

6. A decoding method for a dynamic recognizable two-dimensional code, applicable to a first electronic device having a display unit and a second electronic device having a camera unit, includes the following steps of:
providing at least a two-dimensional code, wherein the two-dimensional code is an image encoded according to a two-dimensional code format;
providing at least a recognizable image, wherein the recognizable image is recognizable by human eyes;
sequentially displaying the at least a two-dimensional code and the at least a recognizable image on the display unit of the first electronic device according to a displaying pattern, wherein the displaying pattern defines a displaying sequence of displayed images, a displaying duration of each of the displayed images, and a time interval to a displayed image next in the sequence, defined as the time lapse between a displayed image ending and a next displayed image appearing; and wherein each of the displayed images being one of the at least a two-dimensional code or the at least a recognizable image;
using the camera unit of the second electronic device to capture the dynamic recognizable two-dimensional code displayed on the display unit of the first electronic device;
performing decoding on the dynamic recognizable two-dimensional code, and to determine the at least a two-dimensional code and the at least a recognizable image, and the displaying pattern;
defining the determined two-dimensional codes as a first state, defining the determined recognizable images as a second state, and defining the first state and the second state to be opposite to each other;
computing to obtain a verification code based on the sequence of the displayed images, the determined states of two-dimensional codes, the determined states of recognizable images, and the determined displaying pattern; and
determining whether a subsequent operation is performed based on the computed verification code.

7. The decoding method for a dynamic recognizable two-dimensional code as claimed in claim 6, wherein the recognizable image is an image that is recognizable by human eyes, but not be recognized by a two-dimensional code decoder in accordance with the two-dimensional code formats, a blank image, a transparent page or any combination of the above.

8. The decoding method for a dynamic recognizable two-dimensional code as claimed in claim 6, wherein the displaying duration of each of the displayed images is not all the same, and the time interval to a displayed image next in the sequence is not all zero.

9. The decoding method for a dynamic recognizable two-dimensional code as claimed in claim 8, wherein the displaying duration of each of the displayed images is the same, and the time interval to a displayed image next in the sequence is zero.

10. The decoding method for a dynamic recognizable two-dimensional code as claimed in claim 6, wherein the subsequent operation includes interaction between the first electronic device and the second electronic device.

11. The decoding method for a dynamic recognizable two-dimensional code as claimed in claim 6, wherein the subsequent operation includes decoding and using the data encoded in the two-dimensional codes of the dynamic recognizable two-dimensional code.
